(19) United States
(12) Patent Application Publication
(10) Pub. No.: US 2017/0034122 A1
(43) Pub. Date: Feb. 2, 2017

(54) MULTI TENANCY IN SOFTWARE DEFINED NETWORKING

(71) Applicant: NOKIA SOLUTIONS AND NETWORKS MANAGEMENT INTERNATIONAL GMBH, Munich (DE)

(72) Inventor: Klaus HOFFMANN, Munich (DE)

(21) Appl. No.: 15/302,729

(22) PCT Filed: Apr. 11, 2014
(86) PCT No.: PCT/EP2014/057407

§ 371 Date: Oct. 7, 2016

(51) Int. Cl. H04L 29/12; H04L 12/46

(52) U.S. Cl. CPC H04L 61/2015; H04L 12/4641

(57) ABSTRACT

A processing entity (10) requests an SDN control entity (20) of a virtual network system to perform a specific function for an application processed by the processing entity (10), and indicates an identification of a virtual network operator associated with the application to the SDN control entity (20). The SDN control entity (20) receives the request and performs (S2) the specific function based on the identification of the virtual network operator.

### BACKGROUND OF THE INVENTION

### Field of the invention

The present invention relates to multi tenancy in software defined networking (SDN).

Related background Art

The following meanings for the abbreviations used in this specification apply:

API application programming interface
ATM asynchronous transfer mode
BRAS broadband remote access server
CP control plane
DHCP dynamic host configuration protocol
eNB evolved nodeB
EPC evolved packet core
ForCES forwarding and control element separation
GPRS general packet radio service
GTP GPRS tunneling protocol
ID identifier
IP internet protocol
L layer
MME mobility management entity
NB northbound
NE network element
NFV network functions virtualisation
OF openflow
OFC openflow controller
PCE path computation element
PDN packet data network
P-GW PDN gateway
PIP protective IP
RAN radio access network
RAT radio access technology
SDN software defined networking
S-GW serving gateway
TEID tunnel endpoint ID
UDP user datagram protocol
VNP virtual network provider
VNO virtual network operator

The basic idea of SDN is the decoupling of the control plane from the data forwarding plane, which enables a programmable central control of network traffic flows over standardized protocols like openflow. While SDN is in principle independent of the concepts for virtualization/cloud, an SDN control layer can be offered as services in the cloud.

FIG. 1 shows an architecture which mainly separates CP and UP functions of a P-GW and S-GW further into a P-GW user/data plane (P-GW-U) and a P-GW control plane (P-GW-C) and respectively into S-GW-U and S-GW-C. P-GW-U/S-GW-U can be seen as packet forwarding entities in the transport plane while P-GW-C/S-GW-C may be implemented as virtualized control processes with several instances running in the cloud. In a non-roaming environment, S-GW-C and P-GW-C, S-GW-U and P-GW-U can either be separated or co-located. FIG. 1 shows separated S/P-GW control and user plane functions.

Multi tenancy refers to a principle in software architecture where a single or multiple instances of the software runs on a shared server, serving multiple client-organizations (tenants). In a multi tenancy environment, multiple customers share the same server and/or application, running on the same operating system, on the same hardware, with the same data-storage mechanism.

### SUMMARY OF THE INVENTION

According to some embodiments, the present invention aims at providing methods, apparatuses and a computer program product for supporting multi tenancy in SDN.

This is at least in part achieved by the methods, apparatuses and computer program product as defined in the appended claims.

In the following the invention will be described by way of embodiments thereof with reference to the accompanying drawings.

### BRIEF DESCRIPTION OF THE DRAWINGS

FIG. 1 shows a schematic diagram illustrating an example of an architecture of separated S/P-GW control and user plane functions in SDN.

FIG. 2 shows a schematic diagram illustrating an example of an IP address allocation that is performed in a P-GW-C part of a virtual network system.

FIG. 3 shows a schematic diagram illustrating an example of an IP address allocation that is performed in an openflow controller of a virtual network system according to an implementation example of the invention.

FIG. 4 shows a signaling diagram illustrating an example of a signaling between a processing entity, an SDN control entity and a serving entity according to an embodiment of the invention.

FIG. 5 shows a schematic block illustrating an example of a configuration of a control unit in which examples of embodiments of the invention are implementable.

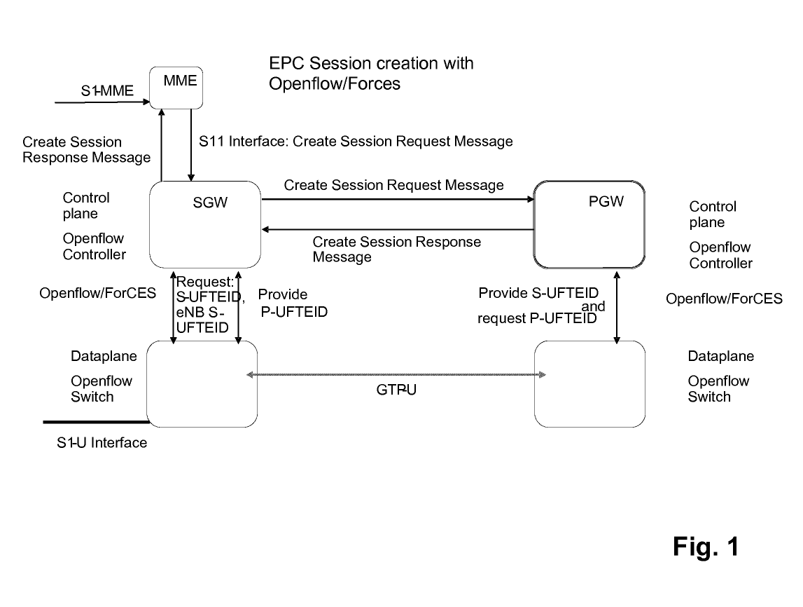

### DESCRIPTION OF THE EMBODIMENTS

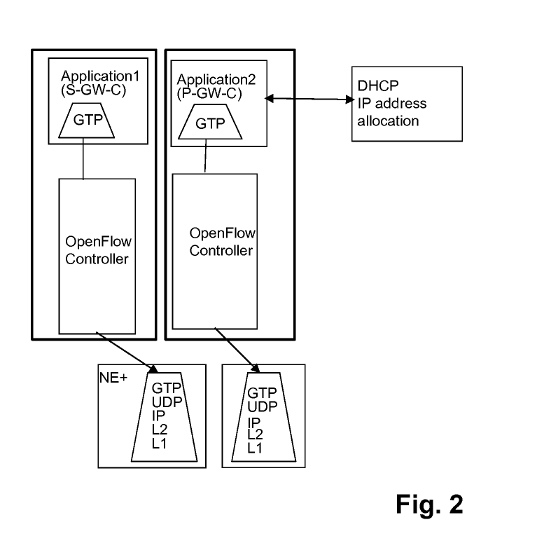

Today's integrated P-GWs or semi-integrated P-GWs which are decomposed into user plane and control plane, but not into a third openflow controller, retrieve an IP address for a mobile user, as illustrated in FIG. 2.

FIG. 2 shows a schematic diagram illustrating an example of an IP address allocation that is performed in a P-GW-C part of a virtual network system. The virtual network system comprises two openflow controllers, respectively accessed, using a GPRS tunneling protocol (GTP), by an application 1 processed by an S-GW-C and an application 2 processed by the P-GW-C. According to FIG. 2, the P-GW-C performs DHCP IP address allocation by communicating with a corresponding server dedicated to a virtual network operator associated with the application 2. The openflow controllers each are connected to network elements using for instance GTP, UDP, IP, L2 or L1 protocol. According to FIG. 2, any VNO may have its own dedicated DHCP server allocating its own IP addresses as required from its reserved address range.

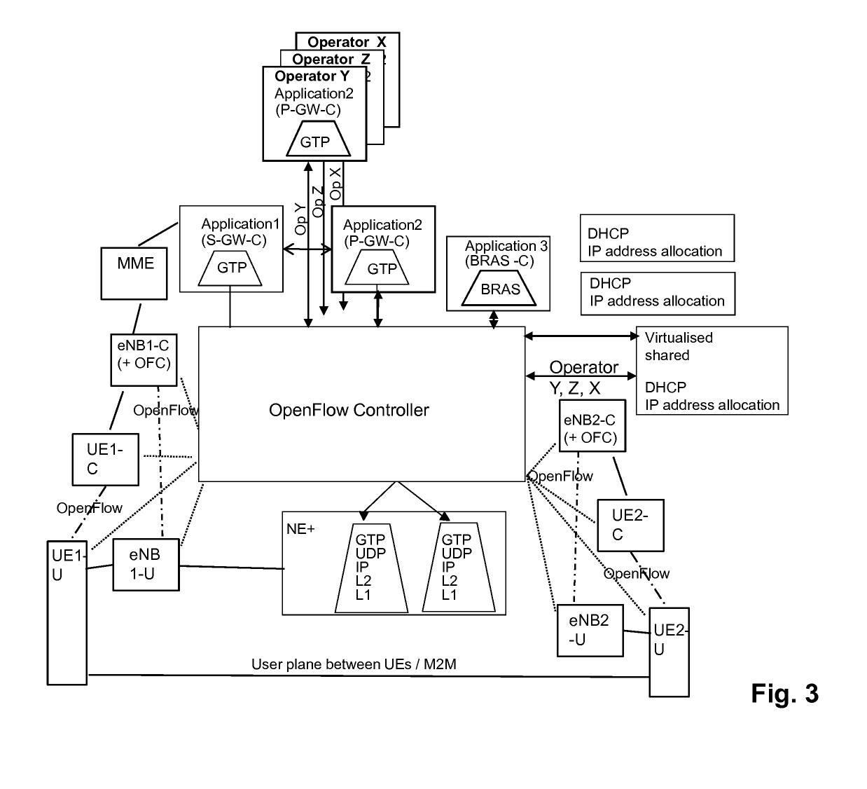

Instead of keeping the allocation procedure, such as the DHCP procedure or a procedure from a radius/diameter server, in the P-GW-C, according to some embodiment of the present invention, the P-GW-C and also any BRAS-C are made protocol and topology independent by moving, e.g., the DHCP allocation procedure from the P-GW-C to an openflow controller, as illustrated in FIG. 3. FIG. 3 shows a schematic diagram illustrating an example of an IP address allocation that is performed in the openflow controller of a virtual network system according to an implementation example of the invention.

The virtual network system of FIG. 3 comprises the openflow controller which is accessed by an application 1 processed by an S-GW-C, using a GPRS tunneling protocol (GTP), an application 2 processed by the P-GW-C, using the GTP, and an application 3 processed by the BRAS-C, using a BRAS protocol. The openflow controller is connected to a network element using GTP, UDP, IP, L2 or L1 protocol.

A UE1 (i.e. a user equipment/device/circuitry and/or a user application) shown on the left hand side in FIG. 3 accesses the virtual network system via an eNB1 (eNodeB) having separated control and user planes as has the UE1. The control plane of the eNB1 (i.e. the eNB1-C) connects the control plane of the UE1 (i.e. the UE1-C) via an MME to the S-GW-C. The user plane of the eNB1 (i.e. the eNB1-U) connects the user plane of the UE1 (i.e. the UE1-U) to the network element. The UE1-U, UE1-C, eNB1-U, eNB1-C are connected to the openflow controller via the openflow protocol. It is to be noted that the invention is not limited to a single openflow controller as depicted in FIG. 3, and there may be several openflow controllers which are responsible for different domains/specific functions. For example, there may be an openflow controller which is responsible for connecting the UE to the virtual network system, as indicated by ‘+OFC’ of the eNB1-C.

FIG. 3 shows a further UE2 (i.e. a user equipment/device/circuitry and/or a user application) on the right hand side which connects to the virtual network system via an eNB2 (e.g. an eNodeB). The UE2 and the eNB2 have separated control and user planes.

FIG. 3 further shows a direct communication between the UEs UE1 and UE2 via their user planes UE1-U and UE2-U. In other words, a machine-to-machine (M2M) tunnel is established.

The virtual network system shows a virtualized shared DHCP IP address allocation which is performed by the openflow controller as will be described in more detail below.

UE addressing is not limited to DHCP, and ATM or any future address allocation protocol can be used for addressing the UE.

To make the applications like the PGW-C and BRAS-C truly independent from the underlying transport topology it is advantageous to let the openflow controller serve the applications instead of placing it into the PGW-C application layer for every virtual operator.

In order to support multi tenancy it is therefore suggested that the application implicitly or explicitly request the underlying enhanced openflow controller to perform a specific function (e.g. IP address allocation for the UE1), and additionally indicate an identification of a virtual network operator (VNO) associated with the application.

As the IP address for the UE1 will be allocated together with an allocation of e.g. a GTP tunnel, the address allocation can preferably be carried along with a NB API and/or SDN messages like MOD-Flow or ADD-Flow, which are exchanged between the application and the openflow controller in order to setup a GTP tunnel or IP tunnel, etc.

As can be seen from FIG. 3, also a network to network tunnel is possible, e.g. between PGW and SGW, also between eNB and SGW or between SGSN and SGW, etc. It is also possible to set up a tunnel between UEs, as described above.

In turn, the openflow controller then queries a server, e.g., a DHCP server (virtualized/centralized/shared) with the indication for which VNO the IP address allocation is to be performed. In other words, according to the implementation example of FIG. 3, the openflow controller performs virtualised shared DHCP IP address allocation based on the identification of operator X, Y, Z for application 1, 2, 3.

It is to be noted that the query to the DHCP is again also just one example of one particular query, and the invention is not limited thereto.

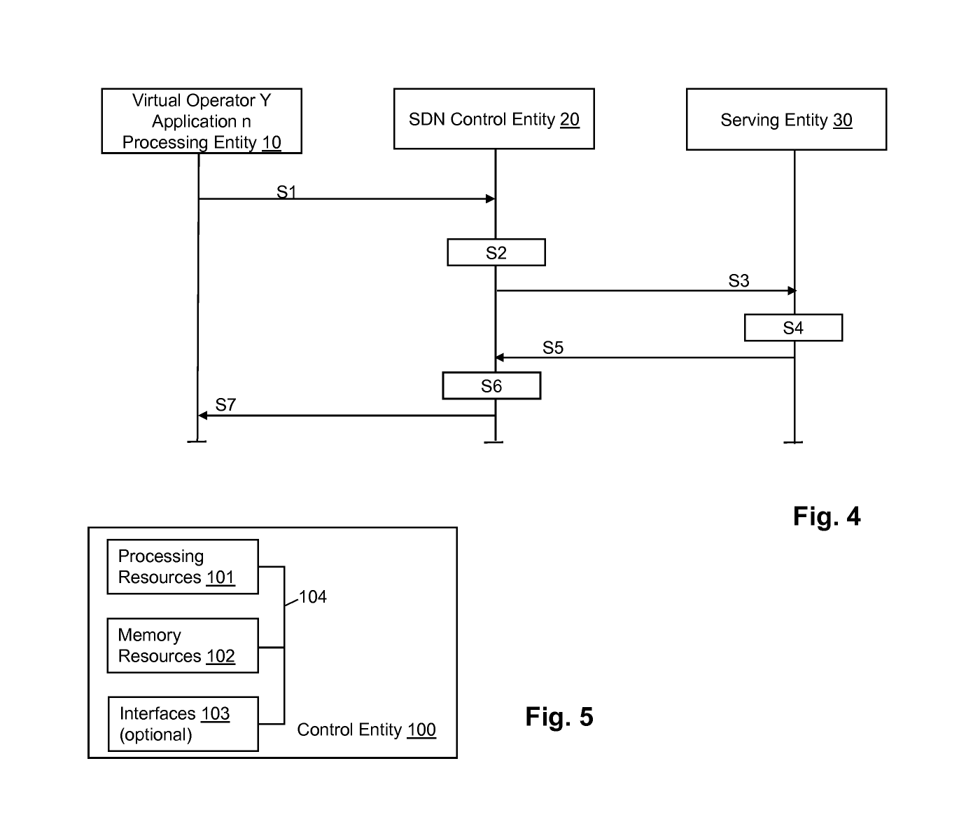

FIG. 4 shows a signaling diagram illustrating an example of a signaling between a entity 10, an SDN control entity 20 and a serving entity 30 according to an embodiment of the invention. The processing entity 10 processes an application n which is associated with an operator Y.

The term “entity” comprises a device/circuitry, e.g. a not virtualized device/circuitry, and/or an application/software, e.g. a virtualized application/software in a datacenter.

According to an implementation example of the invention, the processing entity 10 comprises the P-GW-C shown in FIG. 3. However, the processing entity 10 is not limited thereto, and may further comprise an S-GW-G and BRAS-C, etc.

According to an implementation example of the invention, the SDN control entity 20 comprises the openflow controller shown in FIG. 3, and the serving entity 30 comprises the virtualized shared DHCP IP address allocation shown in FIG. 3.

In step S1 in FIG. 4, the processing entity 10 requests the SDN control entity 20 to perform a specific function for the application n, and indicates an identification (ID) of the virtual network operator Y to the SDN control entity 20. For example, the specific function is an address allocation for a user equipment, e.g. the UE1 shown in FIG. 3. Alternatively or in addition, the specific function is an address allocation for a network entity of the virtual network system.

According to an implementation example, the requesting and indicating of step S1 is performed together with exchanging messages between the processing entity 10 and the SDN control entity 20 for setting up a tunnel between the UE1 and the service.

In step S2, the SDN control entity 20 receives the request to perform the specific function for the application n and the identification of the virtual network operator Y associated with the application n, and performs the specific function based on the identification of the virtual network operator Y. For example, the SDN control entity 20 performs the specific function based on the identification of the virtual network operator Y by communicating with the serving entity 30 in step S3.

According to an embodiment of the invention, a wrapper interface/protocol is introduced, which is set up between the SDN control entity 20 and the serving entity 30, e.g. DHCP, DNS, and PCE server, Diameter, H.248, etc. As a result it can be avoided that each protocol related to the serving entity 30 needs to be modified by adding a VNO ID to that particular protocol, but by adding the VNO ID (and further information to be added to the protocol due to evolvements of SDN environment) to the wrapper/container protocol instead. For instance, the SDN control entity 20 sets up e.g. a DHCP request or DNS request and includes content data into the wrapper protocol with also adding/pre-pending at least the VNO ID. In turn the serving entity 30 such as the DHCP and DNS server, PCE, etc., is also encapsulated such that there is a “dispatcher” which distributes the wrapped query together with the VNO ID to the correct instance. In turn the queried serving entity 30 performs a similar action as described for the SDN control entity 20 when creating the response to the query received, or when creating a request on its own. The SDN control entity 20 then dispatches and receives the response in a similar way.

Referring to FIG. 4, in step S4 the serving entity 30 processes the query from the SDN control entity 20 received in step S3, and returns a response to the query to the SDN control entity 20 in step S5. According to an example embodiment of the invention, the communication between the SDN control entity 20 and the serving entity 30 is performed based on the wrapper/container interface/protocol described above.

With the above implementation, the impact to existing servers are restricted to the minimum, if not completely avoided.

Additionally, the SDN control entity 20 can, based on the receipt of a response of any serving entity, evaluate the outcome (step S6 in FIG. 4) and is able to determine which additional serving entity is to be queried/involved for the service.

Regardless of which service has been triggered, the related information, in the implementation example of FIG. 3 for instance the IP address for the UE1, is handed over to the application of the VNO requesting the service (application n of VNO Y in FIG. 3) via a northbound API (e.g. OpenFlow or ForCES, H.248, etc.). Referring to FIG. 4, in step S7 the SDN control entity 20 responds to the request from the processing entity 10.

According to an example embodiment of the invention, the mechanism of the wrapper protocol/interface (and the addition of the VNO ID or a representation of it) as described above is applied also for the application requesting the service, e.g. the processing entity 10 (e.g. the PGW-C for the IP allocation as shown in FIG. 3).

With this approach, existing protocols can be reused as a northbound interface between the processing entity 10 and the SDN control entity 20.

The introduction of a virtualized DHCP server and the placement of the address allocation on SDN control layer as illustrated in FIG. 3 allows also a flexible support/request of IP addresses. For instance if one VNO of a group of VNOs hosted by the SDN control entity 20 does not need the IP addresses of its traditionally pre-reserved addresses as currently done in legacy equipment, the virtualized DHCP server (serving entity 30)/SDN control entity 20 may provide those spare IP addresses to a VNO, which is looking for IP address resources as the address ranges of the involved may have been pooled.

In the final stage it will be highly beneficial to have an independent application by removing completely any knowledge and dependencies to IP addresses, TEIDs (GTP), topology or the like from the higher layer application. For instance, the higher layer application connected via NB to the OpenFlow controller (SDN control entity 20) can simply indicate its application (number, ID) to the underlying controller together with the ID of the VNO (virtual network operator) to delegate the lower level function by abstraction to the OpenFlow Controller (SDN control entity 20).

The IP address allocation is just one implementation example of the invention. At least according to some embodiments of the invention it is possible to make an application (BRAS-C or PGW -C) truly independent from the underlying transport network and any allocation procedure.

Furthermore, even the generic address allocation is again only an implementation example of the invention for a more general wider family of applications like for instance the DNS and PCE.

The DHCP service, since directly attached to the OpenFlow Controller is, of course, an application in the sense of the SDN. As such the DHCP interface will be a NB interface, which does not need to be an API directly residing on top of the OF controller.

OpenFlow is just an implementation example of the invention for the interface between the higher layer application and the underlying SDN control entity 20. ForCES can also be used for this purpose.

With the introduction of a wrapper protocol/interface carrying at least the VNO ID and the corresponding inner protocol, a more or less generic northbound interface can be introduced, instead of defining an NB API, because the existing protocol can be easily reused, and the wrapper is a means for exchanging the underlying protocol, which avoids unwanted impacts on existing applications.

According to an implementation example of the invention, the wrapper protocol looks like the following:

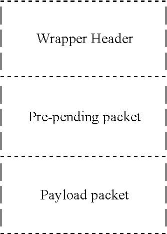

The payload packet contains the packets as for instance the DHCP protocol packets.

The pre-pending packet contains for instance at least the VNO ID to differentiate between several virtual network operators and may be optionally augmented with further indications as required.

The wrapper header constitutes the wrapper protocol to carry the existing protocol packets (like for instance the DHCP, DNS or PCEP packets).

Now reference is made to FIG. 5 for illustrating a simplified block diagram of an example of a control entity 100 that is suitable for use in practicing the example embodiments of this invention. The processing entity 10 and the SDN control entity 20 each may comprise and/or use a control entity such as the control entity 100.

The control entity 100 comprises processing resources 101, memory resources 102 storing a program, and optionally interfaces 103, which are connected via a link 104. The program is assumed to include program instructions that, when executed by the processing resources 101, enable the control unit 100 to operate in accordance with the example embodiments of this invention, as detailed above.

In general, the example embodiments of this invention may be implemented by computer software stored in the memory resources 102 and executable by the processing resources 101, or by hardware, or by a combination of software and/or firmware and hardware.

The memory resources 102 may comprise one or more memories of any type suitable to the local technical environment and may be implemented using any suitable data storage technology, such as semiconductor-based memory devices, magnetic memory devices and systems, optical memory devices and systems, fixed memory and removable memory. The processing resources 101 may comprise one or more processors of any type suitable to the local technical environment, and may include one or more of general purpose computers, special purpose computers, microprocessors, digital signal processors (DSPs) and processors based on a multi-core processor architecture, as non-limiting examples.

According to an aspect of the invention, a processing entity for accessing a software defined networking (SDN) control entity of a virtual network system is provided. According to an embodiment of the invention, the processing entity comprises the processing entity 10 shown in FIG. 4. According to an implementation example of the invention, the processing entity comprises and/or uses a control entity such as the control entity 100 of FIG. 5.

According to an implementation example of the invention, the processing entity comprises a processing device/processing circuitry. Alternatively or in addition, the processing entity comprises a processing application.

According to an implementation example of the invention, the SDN control entity comprises an SDN control device/SDN control circuitry. Alternatively or in addition, the SDN control entity comprises an SDN control application.

The processing entity comprises means for requesting the SDN control entity to perform a specific function for an application processed by the processing entity, and means for indicating an identification of a virtual network operator associated with the application to the SDN control entity.

According to an implementation example of the invention, the specific function is an address allocation for a user entity. Alternatively or in addition, the specific function is an address allocation for a network entity.

According to an implementation example of the invention, the network entity comprises a network device/network circuitry, and the user entity comprises a user device/user circuitry. Alternatively or in addition, the network entity comprises a network application and the user entity comprises a user application.

According to an implementation example of the invention, user plane and control plane are separated in the processing entity and/or the user entity and/or the network entity.

According to an implementation example of the invention, the means for requesting and the means for indicating comprise the requesting and indicating together with exchanging messages between the processing entity and the SDN control entity for setting up a tunnel between the user entity and another user entity and/or for setting up a tunnel between the user entity and the network entity and/or for setting up a tunnel between the network entity and another network entity.

According to an implementation example of the invention, the processing entity comprises means for including the request to perform the specific function and the identification of the virtual network operator into packets of a specific protocol.

According to an implementation example of the invention, the means for requesting, indicating and including are implemented by the processing resources 101, memory resources 102 and, optionally, the interfaces 103 of the control entity 100.

According to another aspect of the invention, a software defined networking (SDN) control entity of a virtual network system is provided. According to an embodiment of the invention, the SDN control entity comprises the SDN control entity 20 shown in FIG. 4. According to an implementation example of the invention, the SDN control entity comprises and/or uses a control entity such as the control entity 100 of FIG. 5.

According to an implementation example of the invention, the SDN control entity comprises an SDN control device/SDN control circuitry. Alternatively or in addition, the SDN control entity comprises an SDN control application.

The SDN control entity comprises means for receiving a request to perform a specific function for an application processed by a processing entity, the request indicating an identification of a virtual network operator associated with the application, and means for performing the specific function based on the identification of the virtual network operator.

According to an implementation example of the invention, the specific function is an address allocation for a user entity. Alternatively or in addition, the specific function is an address allocation for a network entity.

According to an implementation example of the invention, the network entity comprises a network device/network circuitry, and the user entity comprises a user device/user circuitry. Alternatively or in addition, the network entity comprises a network application and the user entity comprises a user application.

According to an implementation example of the invention, the means for receiving comprise receiving the request to perform the specific function and the identification of the virtual network operator in packets of a specific protocol.

According to an implementation example of the invention, the means for performing the specific function based on the identification of the virtual network operator comprise means for communicating with a serving entity providing the specific function based on the specific protocol.

According to an implementation example of the invention, the serving entity comprises a serving device/serving circuitry. Alternatively or in addition, the serving entity comprises a serving application.

According to an implementation example of the invention, the means for receiving, performing and communicating are implemented by the processing resources 101, memory resources 102 and, optionally, the interfaces 103 of the control entity 100.

It is to be understood that the above description is illustrative of the invention and is not to be construed as limiting the invention. Various modifications and applications may occur to those skilled in the art without departing from the true spirit and scope of the invention as defined by the appended claims.

1.-23. (canceled)

24. A method for use in a processing entity for accessing a software defined networking (SDN) control entity of a virtual network system, the method comprising:
requesting the SDN control entity to perform a specific function for an application processed by the processing entity; and
indicating an identification of a virtual network operator associated with the application to the SDN control entity,
wherein the request to perform the specific function and the identification of the virtual network operator are included into packets of a wrapper protocol between the SDN control entity and a serving entity providing the specific function.

25. The method of claim 24, wherein
the specific function is an address allocation for a user entity according to at least one of DHCP and ATM, or
the specific function is an address allocation for a network entity, or
the serving entity is at least one of a DHCP server, DNS, PCE server, Diameter server and H.248 server, or
payload of the wrapper protocol comprises at least one of DHCP packets, DNS protocol packets and PCEP packets.

26. The method of claim 24, wherein user plane and control plane are separated in the processing entity or the user entity or the network entity.

27. The method of claim 25, wherein the requesting and indicating is performed together with exchanging messages between the processing entity and the SDN control entity for setting up a tunnel between the user entity and another user entity or for setting up a tunnel between the user entity and the network entity or for setting up a tunnel between the network entity and another network entity.

28. A method for use in a software defined networking (SDN) control entity of a virtual network system, the method comprising:
receiving a request to perform a specific function for an application processed by a processing entity, the request indicating an identification of a virtual network operator associated with the application; and
performing the specific function based on the identification of the virtual network operator,
wherein the request to perform the specific function and the identification of the virtual network operator are received in packets of a wrapper protocol between the SDN control entity and a serving entity providing the specific function.

29. The method of claim 28, the performing the specific function based on the identification of the virtual network operator comprising:
communicating with the serving entity providing the specific function based on the wrapper protocol.

30. The method of claim 28, wherein
the processing entity comprises a processing device or application, or
the SDN control entity comprises an SDN control device or application, or
the network entity comprises a network device or application, or
the user entity comprises a user device or application, or
the serving entity comprises a serving device or application.

31. A computer program product, embodied on a non-transitory computer readable medium, including a program for a processing device, comprising software code portions for, when the program is run on the processing device, performing the steps of:
requesting the SDN control entity to perform a specific function for an application processed by the processing entity; and
indicating an identification of a virtual network operator associated with the application to the SDN control entity,
wherein the request to perform the specific function and the identification of the virtual network operator are included into packets of a wrapper protocol between the SDN control entity and a serving entity providing the specific function.

32. A computer program product, embodied on a non-transitory computer readable medium, including a program for a processing device, comprising software code portions for, when the program is run on the processing device, performing the steps of:
receiving a request to perform a specific function for an application processed by a processing entity, the request indicating an identification of a virtual network operator associated with the application; and
performing the specific function based on the identification of the virtual network operator,
wherein the request to perform the specific function and the identification of the virtual network operator are received in packets of a wrapper protocol between the SDN control entity and a serving entity providing the specific function.

33. A processing entity comprising at least one processor and at least one memory including computer program code, the at least one memory and the computer program code configured to, with the at least one processor, cause the processing entity at least to perform:
requesting a software defined networking (SDN) control entity of a virtual network system to perform a specific function for an application processed by the processing entity;
indicating an identification of a virtual network operator associated with the application to the SDN control entity; and
including the request to perform the specific function and the identification of the virtual network operator into packets of a wrapper protocol between the SDN control entity and a serving entity providing the specific function.

34. The processing entity of claim 33, wherein
the specific function is an address allocation for a user entity according to at least one of DHCP and ATM, or
the specific function is an address allocation for a network entity, or
the serving entity is at least one of a DHCP server, DNS, PCE server, Diameter server and H.248 server, or
payload of the wrapper protocol comprises at least one of DHCP packets, DNS protocol packets and PCEP packets.

35. The processing entity of claim 33, wherein user plane and control plane are separated in the processing entity or the user entity or the network entity.

36. The processing entity of claim 34, the at least one memory and the computer program code configured to, with the at least one processor, cause the processing entity at least to perform the requesting and indicating together with exchanging messages between the processing entity and the SDN control entity for setting up a tunnel between the user entity and another user entity or for setting up a tunnel between the user entity and the network entity or for setting up a tunnel between the network entity and another network entity.

37. A software defined networking (SDN) control entity of a virtual network system, the SDN control entity comprising at least one processor and at least one memory including computer program code, the at least one memory and the computer program code configured to, with the at least one processor, cause the SDN control entity at least to perform:
receiving, in packets of a wrapper protocol between the SDN control entity and a serving entity providing a specific function, a request to perform the specific function for an application processed by a processing entity, the request indicating an identification of a virtual network operator associated with the application; and
performing the specific function based on the identification of the virtual network operator.

38. The SDN control entity of claim 37, wherein
the specific function is an address allocation for a user entity according to at least one of DHCP and ATM, or
the specific function is an address allocation for a network entity, or
the serving entity is at least one of a DHCP server, DNS, PCE server, Diameter server and H.248 server, or
payload of the wrapper protocol comprises at least one of DHCP packets, DNS protocol packets and PCEP packets.

39. The SDN control entity of claim 37, the performing the specific function based on the identification of the virtual network operator comprising:
communicating with the serving entity providing the specific function based on the wrapper protocol.

40. The SDN control entity of claim 37, wherein
the processing entity comprises a processing device or application, or
the SDN control entity comprises an SDN control device or application, or
the network entity comprises a network device or application, or
the user entity comprises a user device or application, or
the serving entity comprises a serving device or application.
